(19) United States
(12) Patent Application Publication
(10) Pub. No.: US 2009/0082997 A1
(43) Pub. Date: Mar. 26, 2009

(54) METHOD OF IDENTIFYING CLUSTERS AND CONNECTIVITY BETWEEN CLUSTERS

(76) Inventors: Michael G. Tokman, Ithaca, NY (US); Steven J. Schwager, Ithaca, NY (US); Rodolfo R. Rodriguez, Cary, NC (US); Kevin L. Anderson, Cary, NC (US); Ruben N. Gonzalez, Ithaca, NY (US); Ariel L. Rivas, Ithaca, NY (US)

Correspondence Address: PASSE' INTELLECTUAL PROPERTY, LLC, 1717 BRASSFIELD RD., RALEIGH, NC, 27614, US

(21) Appl. No.: 12/158,398

(22) PCT Filed: Dec. 21, 2006
(86) PCT No.: PCT/US06/62457

§ 371 Date: Jun. 20, 2008

Related U.S. Application Data
(60) Provisional application No. 60/752,325, filed on Dec. 21, 2005.

(51) Int. Cl. G06F 19/00

(52) U.S. Cl. 702/179

(57) ABSTRACT

The present invention relates to a method for predicting outcome and evaluation of clusters. Particularly the invention relates to a method of determining deviation and predict future out comes of clusters with certain attributes. In one embodiment, the present invention relates to epidemic outbreaks of disease and, more particularly, to a method for predicting the spread thereof.

### BACKGROUND OF THE INVENTION

1. Field of the Invention

The present invention relates to a method for predicting outcome and evaluation of clusters. Particularly the invention relates to a method of determining deviation and predict future out comes of clusters with certain attributes. In one embodiment, the present invention relates to epidemic outbreaks of disease and, more particularly, to a method for predicting the spread thereof.

2. Description of the Related Art

The emergence of Global Information Systems (GIS) has opened a new method for analyzing spatial dynamics of clusters for example for epidemics.1 Spatial features (i.e., mountains, cities, rivers, and farms) are rarely distributed in random or regular patterns. They are usually fragmented (discontinuous). Spread of disease during an epidemic may be influenced by factors that include but go beyond topographic features (such as winds, human traffic, road density, and other spatial variables). 2,3

An epidemic process may be regarded as composed of 2 spatial points (e.g., 2 animals, 2 farms, or 2 counties) connected through a line. One of these points is the infector and the other the infected. The line may have multiple forms (e.g., a road or a delivery route). By expanding this concept to that of a network (a set of nodes or points linked by multiple lines), animals located at nodes are expected to be infected during an epidemic that spreads along the lines. Hence, the issue of interest is to identify the unknown lines of an epidemic network.

Spatial connectivity depends on Euclidean (straight line) and non-Euclidean distances (e.g., connections through roads), which are factors that influence spread of disease during an epidemic.8 Euclidean distance can be estimated by measuring the distance between centroids (e.g., farm or county centroids).9 Non-Euclidean distance can be assessed by estimating total (major and minor) road density, which tends to be linearly predicted by major road density.10

Epidemic spatial connectivity may be investigated by use of classic spatial statistical techniques. They include the Moran/test (which assesses spatial autocorrelation), Mantel test (which measures spatial-temporal autocorrelation), and their derived correlograms. The correlograms identify the distance or time lag within which spatial autocorrelations extend.11,12 The Moran test evaluates whether there is a spatial autocorrelation (e.g., whether cases are associated with sites spatially close to each other, such as in adjacent counties). 13 Positive autocorrelation exists when the magnitude of cases increases as spatial proximity increases. Similarly, the Mantel statistic is used to assess spatial and temporal autocorrelation. 14,15

Although local Moran and Mantel tests can quantify the contribution of each specific spatial point to the overall (spatial or temporal-spatial) autocorrelation, 12 most local tests are not spatially explicit because they do not identify the line that connects an infected point to other (susceptible or subsequently infected) points. They are not spatially explicit or, if spatially explicit (i.e., the scan statistic test), not appropriately suited to detect long-distance links (i.e., not appropriate to detect fragmented clusters).16-22 Those limitations could be addressed by local tests that focus on the connecting line between points. Connectivity has been investigated from a network point of view (spatial link analysis) as conceptualized in a classic study and used in various fields.4-7 Together, assessments of spatial-temporal autocorrelation, supplemented with local tests that estimate the contribution to the overall autocorrelation provided by specific connections (spatial links between pairs of infected locations), could spatially identify geographically proximal case clusters (close-distance connections) as well as non-clustered clusters (i.e., cases that are located in spatially fragmented areas and connected by long-distance links).

### SUMMARY OF THE INVENTION

In accordance with the present invention, there is provided a method for identifying and evaluating the relationship between clusters in a set primarily based on the connectivity between such clusters. So in one embodiment thereof, there is provided a method of identifying clusters from a set of points selected from the group consisting of individual points and spatial points comprising:
a) selecting a geographic area;
b) acquiring data on the spatial coordinates that characterize the selected geographic area;
c) selecting attributes to be measured for each point of the set;
d) processing the attributes of each point;
e) determining the linkage between the points based on the attributes;
f) identifying from the group comprising the spatial coordinates and time, of any point having an attribute deviating significantly from the average point in the set as a cluster.

Likewise another embodiment of the invention comprises a method of determining connectivity between a set of points selected from the group consisting of individual points and spatial points comprising:

a) selecting a geographic area; acquiring data on the spatial coordinates that characterize the selected geographic area;

b) selecting attributes to be measured for each point of the set;

c) processing the attributes of each point;

d) determining the linkage between the points based on the attributes;

e) identifying the magnitude of the attributes of any point having an attribute deviating significantly from the average point in the set as a cluster.

In yet another embodiment the invention relates to a method for prediction of the spread of an epidemic outbreak of a disease comprising

a) selecting a geographic area;

b) acquiring data on the spatial coordinates that characterize the selected geographic area;

c) selecting disease attributes to be measured for each point of the set;

d) processing the attributes of each point;

e) determining the linkage between the points based on the attributes;

f) determining the rate of change of the attributes over time.

These and other objects of the present invention will be clear when taken in view of the detailed specification and disclosure in conjunction with the appended figures.

### BRIEF DESCRIPTION OF THE DRAWINGS

A complete understanding of the present invention may be obtained by reference to the accompanying drawings, when considered in conjunction with the subsequent detailed description, in which:

FIGS. 1A and 1B is a schematic, map view of a county location in Uruguay and site of the first herd reported as infected during the 2001 outbreak of FMD (FIG. 1A) and location of farms with infected cattle during the first week of the outbreak (FIG. 1B);

FIGS. 2A-2D are schematic, map views of the number of farms with cattle infected with FMD per county at the beginning (week 1; FIG. 2A), peak (week 4 [FIG. 2B] and week 5 [FIG. 2C]) and end of the 2001 epidemic (week 11; FIG. 2D);

FIGS. 3A-3B illustrate a distribution of the national number of total (susceptible) farms per county (aggregated at the state level; n=18 states; FIG. 3A) and the number of observations for county pairs that contained infected cattle at specific time points (weeks during the outbreak) or distance lags (between county pairs; FIG. 3B);

FIGS. 4A-4B illustrate evidence of significant (P<0.05) case clustering with spatial autocorrelation (Moran I; FIG. 4A) and spatial-temporal autocorrelation (Mantel Iₛ₋ₜ; FIG. 4B) observed during the first 6 weeks of the 11-week epidemic of FMD;

FIGS. 5A-5C illustrate mean spatial correlograms for the periods during the epidemic before vaccination (weeks 1 and 2; FIG. 5A) and after vaccination (weeks 3 through 11; FIG. 5B) and the temporal correlogram for the entire 11 weeks of the epidemic (FIG. 5C);

FIGS. 6A-6B are spatial correlograms calculated for weeks 1 through 6 (FIG. 6A) and 7 through 11 (FIG. 6B) of the epidemic;

FIGS. 7A-7B illustrate contributions of specific links between county pairs that contained infected cattle to the overall autocorrelation index for the period before vaccination (weeks 1 and 2) for county pairs located <120 km apart (FIG. 7A) and a map of the southwestern region of Uruguay indicating the 10 highest spatial infective link indices (lines) between county pairs (FIG. 7B);

FIGS. 8A-8B illustrate contributions of specific links between county pairs that contained infected cattle to the overall autocorrelation index for the period after vaccination (weeks 3 through 11) for county pairs located <120 km apart (FIG. 8A) and a map of the southwestern region of Uruguay indicating the 10 highest spatial infective link indices (lines) between county pairs (FIG. 8B); and

FIGS. 9A-9C illustrate contributions of specific links between county pairs that contained infected cattle to the overall autocorrelation index for the period before vaccination (weeks 1 and 2; FIG. 9A) and after vaccination (weeks 3 through 11; FIG. 9B) for county pairs located >400 km apart and a map of Uruguay that indicates the 4 highest intercounty link indices (lines) before vaccination (FIG. 9C).

### DETAILED DESCRIPTION OF THE PREFERRED EMBODIMENT

The general description of the invention and how to use the present invention are stated in the Brief Summary above. This detailed description defines the meaning of the terms used herein and specifically describes embodiments in order for those skilled in the art to practice the invention. The above interests in evaluating clusters are explained and benefits met as can be seen readily from the disclosure which follows and thus met by the present invention.

As used herein the term “points” refers to individual points or to spatial points. Examples of individual points include people, animals, sites, groups or the like having an attribute as part of a whole set. Examples of spatial points include mountains, cities, rivers, roads and farms. As used herein “attributes” relates to attributes of the points such road accidents, work-related accidents, opinions, social networks, natural resources, weather, computer viruses, crime, epidemics, infections, banking information, internet information and the like.

As used herein the term “spatial coordinates” refers to any bi-dimensional coordinates including things such as distance, height and weight and the like. Distance has its broadest possible meaning. So no only is the measurement of point to point distance included but other abstract distances such as years of service and the like are included.

As used herein, the term “connectivity” refers to the relationship of attributes between two clusters. In other words, a relationship that tells us potential causes or consequences, for example, why or how did something happen, what could happen later, where or how much has happened and the like. One embodiment of this connectivity is the relationship between clusters of infected individuals and non infected individuals and what would happen over time. i.e. how could the disease spread over time. Connectivity can also be used to determine the relative deviation between clusters. So in one embodiment one could look at clusters of individuals and use connectivity to identify a cluster of individuals with a higher rate of disease infection, cancer or the like than other clusters of individuals.

As used herein, “geographic information system” (GIS) refers to a collection of spatial features, topographical features or a combination of the two. The GIS is collected for a specific geographic area for example for a whole country, for a city county or the like. Once a particular geographic area is selected the corresponding GIS is collected for that geographic area.

As used herein, “processing the attributes” refers to sorting, measuring, comparing, ranking the magnitude or like process to correlate the attributes of each point in the set.

As used herein “determining the linkage” refers to determining the number of links per individual or spatial point, the index of each link per individual or spatial point, time the attribute was reported, or combinations of these or the like;

The following embodiment of an epidemic spread further illustrates the invention and teaches one skilled in the art how the invention, works, is applied and calculated.

Presented in one embodiment to test the influence of spatial connectivity on disease dispersal during an epidemic, geographically referenced epidemic data are needed. The 2001 epidemic of FMD in Uruguay offers an opportunity to evaluate diffusion over time and space during an epidemic. Cattle were predominantly infected in a country previously free of FMD. 23-25 The minimal replication cycle of FMD virus is estimated to be 3 days. 26 Studies 27-29 on FMD and other diseases have indicated heterogeneous spatial spread and used the centroids of irregular polygons (i.e., counties) as units of analysis. Road networks may influence dispersal of FMD virus. 24,25,30

3 objectives are met by the present invention: a determination is made to detect whether infected sites are spatially or temporally auto-correlated; if sites are clustered, to measure the contribution of each spatial link to the overall spatial-temporal autocorrelation; and that information is used to generate and evaluate hypotheses on the various potentials for disease spread during an epidemic for specific counties.

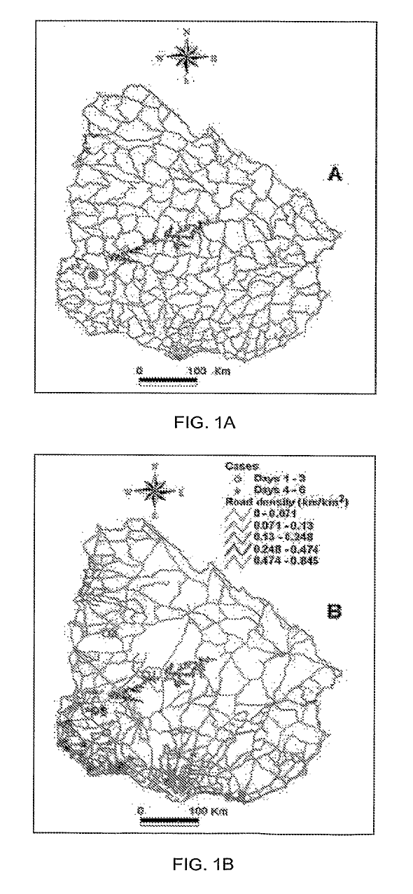

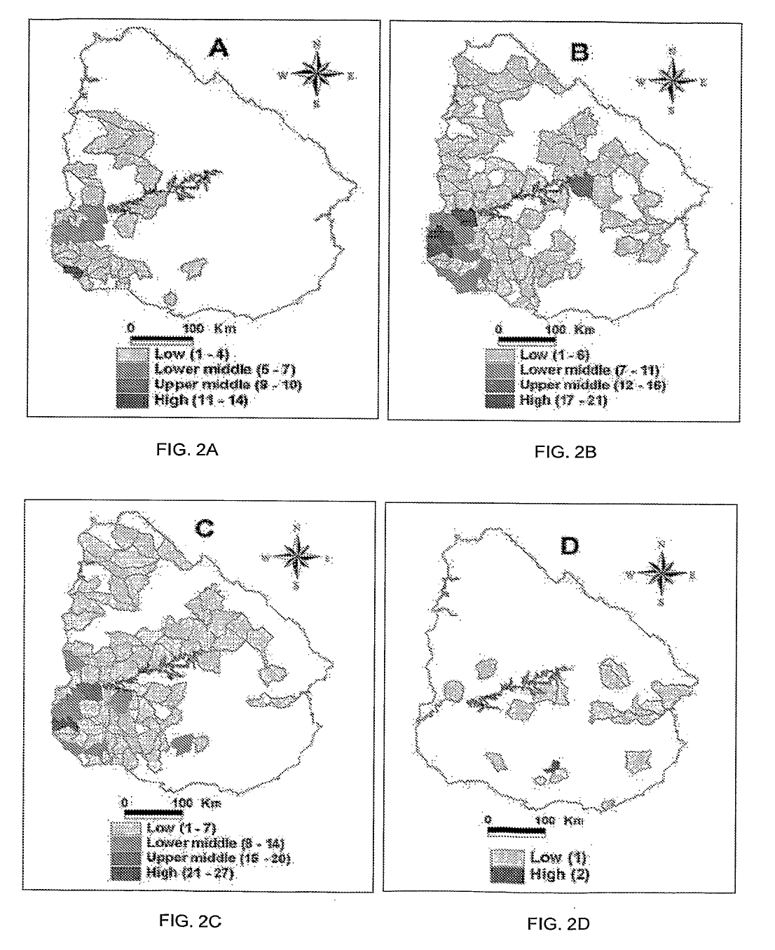

Details of this epidemic have been reported 23-25 elsewhere. Initial cases of FMD were identified in the southwestern quadrant of Uruguay, a non-urban, cattle-raising region characterized by higher road density than the national median (FIGS. 1A-1B and 2A-2D). Several interventions were implemented over time, including a nationwide ban on animal movement (implemented on day 2 of the epidemic) and a nationwide program of vaccination. However, human traffic was not interrupted. Milk trucks continued to visit dairy farms and collect milk throughout the duration of the epidemic. In addition, no vaccines were available in the country at the time the epidemic began.31,32 Although a decision to acquire >10 million doses of vaccine was made within a week after the onset of the epidemic, no data were available in relation to where or when the first vaccination was implemented. It is estimated that at least 3 days are required for immunologically naive animals to synthesize antibodies after vaccination with a high-potency vaccine.33 No spatial-temporal data were available as to whether vaccine-induced antibodies reached protective titers. A second vaccination was implemented later.

Two GIS packages a, b were used to geographically reference data and create maps. An official map of Uruguay, c including the location and area of the 276 counties, was used. On the basis of the 2000 Agricultural Census for Uruguay, 248 counties (cattle-raising regions) were selected. Of those, 163 counties contained infected animals at some time during the 11-week period that began on Apr. 23, 2001. Geographically coded data on weekly (county level) and daily (for the first 6 days only; farm level) number of cases were retrieved from public sources and processed as described elsewhere. 24, 34-37

Four steps were used to determine the intercounty centroid distance. First, the x- and y-coordinates for each county's surface were identified by accessing the x- and y-values in the shape field. Second, the center value for each polygon (centroid) was provided by use of the GIs packages. Third, a point layer was generated from the x- and y-values of the centroid for each county. Fourth, distances between all centroids were calculated by use of the GIS tools, which selected a distance larger than the largest distance between any pair of points in the territory under study.

Three steps were used to generate data on road density. First, the total area of each county was determined by accessing the county value for area. Second, the national highway layer (excluding urban areas)c was intersected with the county layer to characterize and identify road segments by county. Length of road segments was then summarized for each county (i.e., the total length of roads was divided by total area of the county).

The GIs-generated matrix of all pairs of intercounty (centroid-to-centroid) distances (13,203 county pairs), the table containing density of county roads, and the matrix including the number of infected cattle per week and county identifier were transferred into and processed by use of technical computing software.

Spatial connectivity involved Euclidean distances (i.e., number of kilometers) between counties with infected cattle (distance between centroids) and road density (road distance divided by county area, a non-Euclidean distance measure). The Moran I coefficient was used to analyze spatial autocorrelation.13 Positive values for spatial autocorrelation indicate that sites spatially closer to each other than the mean distance have similar numbers of cases, whereas negative values for spatial autocorrelation indicate the opposite. The Moran I coefficient of autocorrelation was calculated as follows:

$$I = ( n {\sum }_{i = 1}^{n} {\sum }_{j = 1}^{n} {w}_{ij} {z}_{i} {z}_{j} ) / ( {S}_{O} {\sum }_{k = 1}^{n} {z}_{k}^{2} ) \qquad Eq . 1$$

where n is the number of counties, i and j are counties (i and j cannot be the same county), wᵢⱼ is the spatial connectivity matrix, zᵢ is the difference between the prevalence in county i and the overall mean prevalence, zⱼ is the difference between the prevalence in county j and the overall mean prevalence, S₀ is an adjustment constant, k is a county index, and zₖ is the difference between the county index and overall index. In addition, zᵢ=xᵢ−x, where xᵢ is the weekly number of cases/100 farms in county i and x is the mean prevalence. The value for wᵢⱼ is calculated by use of the following equation:

wᵢⱼ=f(dᵢⱼ, rᵢ, rⱼ)=(dᵢⱼ)^{-a} (rᵢ rⱼ)^{b} Eq. 2

where dᵢⱼ is the matrix of the Euclidean distance between counties i and j (i and j cannot be the same county), rᵢ is the road density for county i, rⱼ is the road density for county j, the value for variable a is a measure of the degree of epidemic diffusion in relation to distance (i.e., there is greater diffusion at shorter distances),37-41 and the value for variable b is a measure of the extent of connectivity between counties (i.e., greater road density results in greater connectivity), regardless of distance. For fixed positive values of variable a, large values of variable b support local spread as well as long-distance spread because higher local road density is associated with higher interstate highway density. Values for variables a and b were estimated by maximizing the spatial autocorrelation coefficient as reported elsewhere6 as follows:

$${I}^{*} = {\sum }_{t = 1}^{11} I ( t , a , b ) \qquad Eq . 3$$

where a>0, b>0, and t is time (week of the epidemic). The value for S₀ was calculated as follows:

$${S}_{O} = {\sum }_{i = 1}^{n} {\sum }_{j = 1}^{n} {w}_{ij} \qquad Eq . 4$$

where i and j cannot be the same county.

Interactions of space and time were analyzed by use of the Mantel coefficient Iₛ₋ₜ.14,15. The Iₛ₋ₜ coefficient was calculated by use of the following equation:

$${I}_{s \text{-} t} = {\sum }_{i = 1}^{n} {\sum }_{j = 1}^{n} {w}_{ij} {y}_{ij} \qquad Eq . 5$$

where yᵢⱼ indicates the closeness in time between infections and i and j cannot be the same county. The first moments of the Moran I and Mantel Iₛ₋ₜ statistics are reported elsewhere.6 Observations were assumed to be random independent samples from an unknown distribution function relative to the set of all possible values of I or Iₛ₋ₜ when the xᵢ were randomly permuted around the county system.6 The matrix yᵢⱼ was defined as yᵢⱼ=1 when county i had values greater than the mean number of cases/100 farms (total number of susceptible farms/county) at week t and county j also had values greater than the mean number of cases/100 farms at week t−m; otherwise, yᵢⱼ was equal to 0. This cross-correlation at lag m measured the temporal correlation of events at time t and those at a specified preceding point (i.e., m weeks earlier).

Interaction between county pairs was measured as a function of their distance from each other as described elsewhere.6 The graphic display of the global spatial autocorrelation coefficient (Moran I) plotted against the distance lag (correlogram) was determined by use of the following equation:

$${I}_{( g )} = ( n {\sum }_{i = 1}^{n} {\sum }_{j = 1}^{n} {w}_{ij} {z}_{i} {z}_{j} ) / ( {S}_{O} {\sum }_{k = 1}^{n} {z}_{k}^{2} ) \qquad Eq . 6$$

where g is the distance between the 2 counties, the matrix wᵢⱼ contains values of 1 for all the links among county pairs (i, j) located within the distance g and values of 0 for all other links not included within the Euclidean distance g, and i and j are not the same county. The temporal correlogram is the plot of Iₛ₋ₜ as a function of the time lag m. Hence, the temporal correlogram was used to determine the extent of spatial-temporal autocorrelation for various time lags.

On the basis of network analysis, relationships between nodes (i.e., counties) can be described by their links.5,7 County pairs were considered connected by a spatial link when their contribution to the global spatial autocorrelation coefficient did not equal 0. The contribution of specific spatial links was defined as the link strength (index) between counties with infected cattle (i, j) located within a distance g, as indicated by use of the following equation:

$${I}_{ij ( g )} = ( [ {z}_{i} {z}_{j} ] ) / ( {\sum }_{k = 1}^{n} {z}_{k}^{2} ) \qquad Eq . 7$$

where I_{ij (g)} is the contribution of the specific spatial link.

Spatial-temporal autocorrelation and link indices were calculated by use of mathematical software.d Normality (No. of farms/county and link index, which were tested by use of the Anderson-Darling test) and comparisons among medians (assessed by use of the Mann-Whitney test) were conducted by use of a statistical program.e For all tests, values of P<0.05 were considered significant.

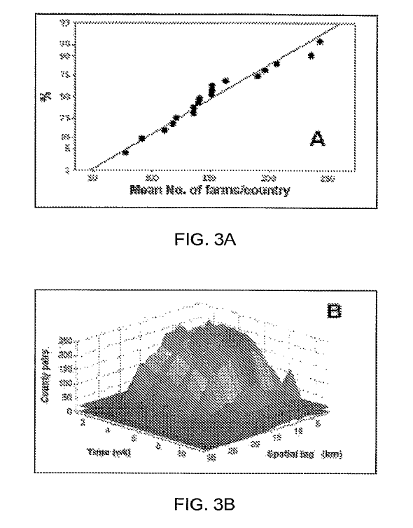

The 2001 epidemic began in the southwest portion of Uruguay and reached a peak (county-level) farm prevalence at week 5 (Table 1). The median road density of all counties reporting infected animals during the first week was 0.24 km/km2, which differed significantly (P=0.01) from that for the remainder of the country (0.12 km/km2; FIG. 1). A dissimilar spatial pattern was observed over time (FIGS. 2A-2D; Table 2). The distribution of the number of susceptible farms per county did not disprove a normal distribution (P>0.05; FIGS. 3A-3B). The normality assumption of the spatial autocorrelation (which requires an estimated minimum of 20 county pairs/observation) was met during at least the first 9 weeks of the epidemic because all distance lags up to approximately 440 km reported >20 county pairs.

TABLE 1
National weekly case prevalence during the first 11 weeks of
an epidemic of FMD in Uruguay that began on Apr. 23, 2001.

| | | | Overall county |
|---|---|---|---|
| | | No. of suceptible farms in | herd prevalence |
| Week of the | No. of new | counties with infected | (per 100 county |
| epidemic | cases* | animals | farms) |
| 1 | 88 | 4,443 | 1.88 |
| 2 | 229 | 11,098 | 2.05 |
| 3 | 220 | 10,584 | 2.08 |
| 4 | 303 | 12,076 | 2.51 |
| 5 | 299 | 10,703 | 2.74 |
| 6 | 235 | 12,791 | 1.84 |
| 7 | 176 | 11,407 | 1.54 |
| 8 | 93 | 9,008 | 1.16 |
| 9 | 41 | 4,876 | 0.88 |
| 10 | 28 | 3,138 | 0.89 |
| 11 | 19 | 2,724 | 0.70 |

^{*}Number of farms reporting infected animals.

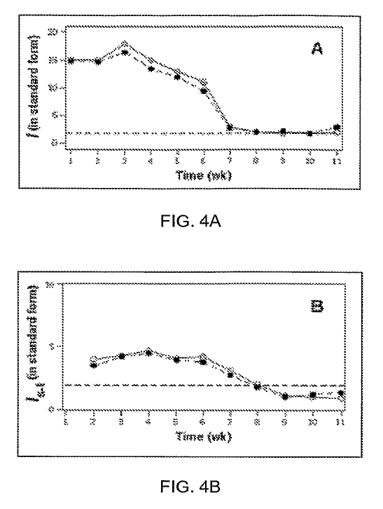

Maximization of the spatial autocorrelation index was evident when variable a=0.46 and variable b=0.06 (data not shown). The Moran I null hypothesis (lack of spatial autocorrelation) was rejected. Until at least the sixth week of the epidemic, sites closer to each other (clusters) had significantly more infected cattle than sites located at the mean (or greater) distance from each other (FIGS. 4A-4B). In addition, analysis of the Mantel Iₛ₋ₜ indicated that in weeks 1 through 6, spatial clusters were associated with time because adjacent sites had significantly more infected cattle at shorter time periods than sites more distant in time and place. Because exotic diseases have zero prevalence before an outbreak and every infection needs to be controlled (regardless of the size of the susceptible population), Mantel and Moran tests were also calculated without considering the total size of the susceptible population, and both calculations yielded similar results.

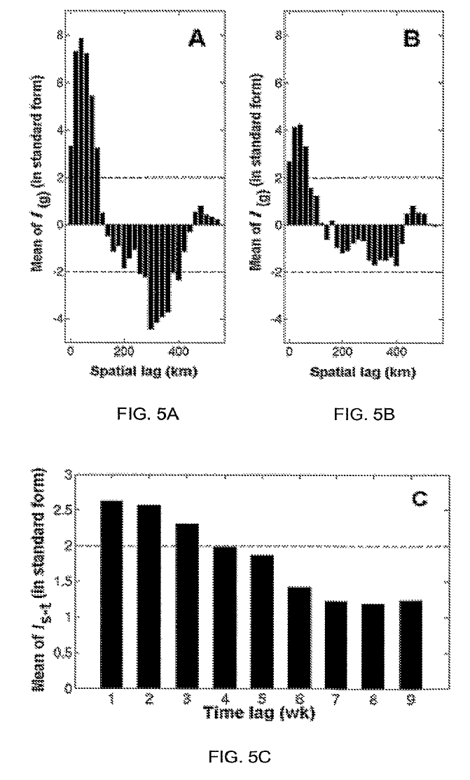

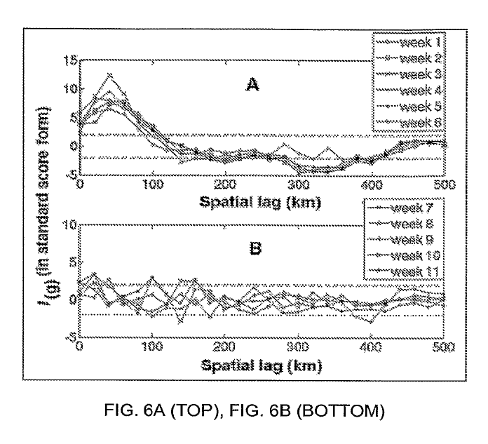

Analysis of spatial correlograms (conducted before and after vaccination was implemented) indicated a significant positive autocorrelation among county pairs with infected animals located within approximately 120 km from each other for weeks 1 and 2 of the outbreak and within 80 km of each other for weeks 3 through 11. A significant negative spatial autocorrelation was observed for county pairs with infected cattle located 120 to 400 km from each other only at weeks 1 and 2 of the outbreak. A second cluster, which was not significant, was evident for county pairs with infected cattle located >400 km from each other (FIGS. 5A-5C). The temporal correlogram indicated significant temporal-spatial autocorrelation for time lags of up to 3 weeks (m<4). When specific weeks were considered, spatial correlograms did not reveal regional effects. During the first 6 weeks of the epidemic, significant positive spatial autocorrelation was observed each week for county pairs with infected cattle located within 120 km of each other, whereas a significant negative autocorrelation lasted for at least the first 5 weeks (FIGS. 6A-6B).

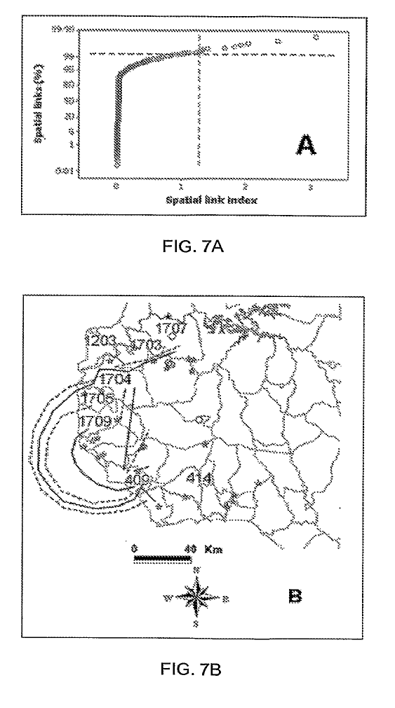

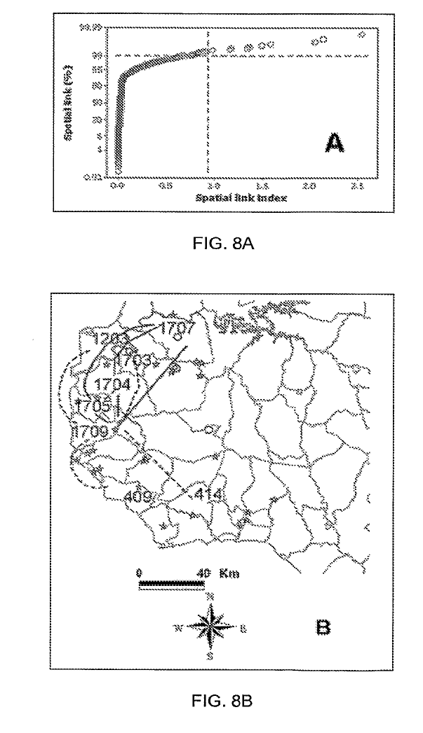

Analysis of infective link indices (percentage of the overall spatial autocorrelation explained by specific infective links) revealed a clear departure from normality (FIGS. 7A-9C). County pairs with infected cattle located <120 km from each other during weeks 1 and 2 had 10 links (including 5 different counties) with indices substantially higher than the mean. Three of those 5 counties also had the highest link indices at weeks 3 through 11. The remaining 2 counties were involved in significant long-distance links for weeks 1 and 2, and analysis also suggested that they departed from normality, but not significantly, for weeks 3 through 11 (Table 2).

TABLE 2
Infective connectivity for county pairs containing cattle
infected with FMD that had the highest index link.

| | | | County | |
|---|---|---|---|---|
| | | | connecting | |
| | | | with ≧2 other | |
| | | Infective | counties | |
| Time period and | County | link | through a high | No. of |
| distance | pairs | index* | index link | links† |
| Before vaccination | 409, 1704 | 3.07 | 409 | 7 |
| and <100 km | 409, 1709 | 2.49 | 1704 | 4 |
| between county | 409, 1707 | 2.02 | 1707 | 2 |
| pairs‡ | 407, 409 | 1.91 | 1709 | 2 |
| | 1704, 1709 | 1.81 | 407 | 2 |
| | 409, 1705 | 1.83 | NA | NA |
| | 409, 412 | 1.40 | NA | NA |
| | 409, 1708 | 1.33 | NA | NA |
| | 407, 1704 | 1.32 | NA | NA |
| | 1704, 1707 | 1.31 | NA | NA |
| After vaccination | 1707, 1709 | 2.54 | 1709 | 6 |
| and <100 km | 1705, 1709 | 2.14 | 1704 | 3 |
| between county | 1704, 1709 | 2.05 | 1707 | 3 |
| pairs§ | 1704, 1707 | 1.58 | 1705∥ | 3 |
| | 1705, 1707 | 1.49 | NA | NA |
| | 1703, 1709 | 1.93 | NA | NA |
| | 414, 709 | 1.94 | NA | NA |
| | 409, 1709 | 1.17 | NA | NA |
| | 1704, 1705 | 1.15 | NA | NA |
| Before vaccination | 105, 409 | 3.37 | 409# | 1 |
| and >400 km | 105, 407 | 2.17 | 407# | 1 |
| between county | | | | |
| pairs¶ | | | | |

*Percentage of the overall spatial autocorrelation index explained by a specified spatial infective link index connecting 2 counties it is assumed to be the infector and the other is assumed to be the target.
†Counties with ≧2 links (both of which had high indices) are regarded to possess greater potential for epidemic spread (infector site), whereas those observed with only 1 link or observed at a later time during the epidemic are regarded as target sites.
‡Represents weeks 1 and 2 during the epidemic for 2.306 spatial links with a mean ± SD link index of 0.043 ± 0.15.
§Represents weeks 3 through 11 during the epidemic for 2,151 spatial links with a mean ± SD link index of 0.046 ± 0.14.
∥County No. 1705 did not appear to have links by itself because all 3 links to it are explained by links for counties Nos. 1704, 1707, and 1709.
¶Represents weeks 1 and 2 during the epidemic for 394 spatial links with a mean ± SD link index of 0.254 ± 0.23.
#Because counties Nos. 407 and 409 already contained infected cattle at week 1 and county No. 105 did not report infected cattle until week 5, these connections appear to rule out county No. 105 as the site that infected counties Nos. 407 and 409.

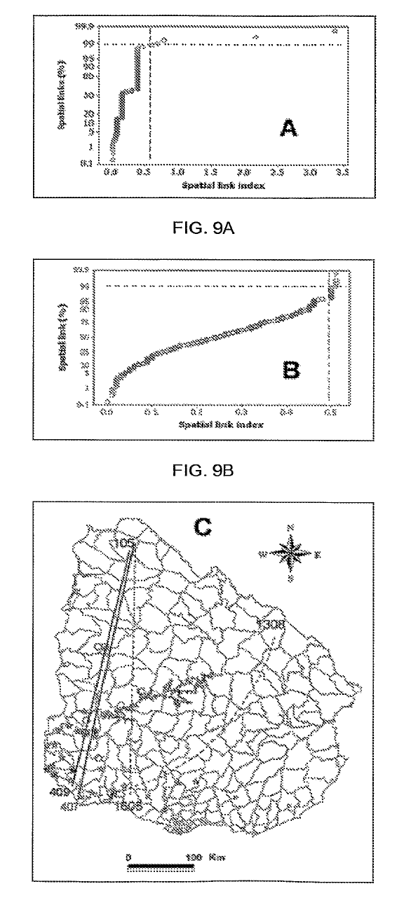

Analysis of the data suggested 3 classes of counties in terms of potential disease dispersal during the epidemic. The first class included 5 counties in which infected cattle were observed within the first 3 days of the epidemic (minimal time compatible with a replication cycle of the infective agent; hence, possible primary cases; FIG. 7A-7B). All of these counties, except for 1, had low index links. The second class included 5 counties that had the highest index links connecting with ≧2 other counties. One of the counties was possibly a primary site (with infected animals reported within 3 days of the outbreak), whereas the other 4 counties all reported infected cattle within 4 to 6 days of the epidemic. These counties had both short- and long-distance connections. The third class involved counties reporting infections after week 1 of the epidemic and had mean link indices (counties regarded as targets). When 2 counties were connected, time during the epidemic helped to generate hypotheses that distinguished the putative infector (earlier case) from the putative infected (later case [target]; FIGS. 9A-9C; Table 2). When 1 county of the pair connected by a high index link was involved in multiple links, but the other county was not, the first county was hypothesized to be the infector (Table 3).

TABLE 3
Comparison of control efficacy for an outbreak of FMD on
the basis of spatial-based versus traditional approaches.

| | | | | | Traditional approach† | | | |
|---|---|---|---|---|---|---|---|---|
| Spatial-based approach* | | | | | | | All cases | Cases/km² |
| | | | All cases | | | | reported | in primary |
| | County | County | reported | Cases/km² | | Primary | in primary | counties |
| | Spatial | area | through | through | Primary | county | counties | through |
| County No. | links | (km²) | week 11 | week 11 | county No. | area (km²) | through week 11 | week 11 |
| 407 | 2 | 382.0 | 28 | 0.073 | 1108 | 2,252.2 | 13 | 0.006 |
| 409 | 7 | 474.0 | 72 | 0.152 | 1209 | 1,294.3 | 8 | 0.006 |
| 1704 | 4 | 1,070.2 | 70 | 0.065 | 1708 | 1,176.8 | 37 | 0.031 |
| 1707 | 2 | 1,047.8 | 69 | 0.066 | 1707‡ | 1,047.8 | 69 | 0.027 |
| 1709 | 2 | 763.8 | 93 | 0.122 | 1708 | 1,218.8 | 33 | 0.066 |
| Totals§ | NA | 3,737.8 | 332 | 0.478 | NA | 6,989.9 | 160 | 0.136 |
| Median∥ | NA | 905.8 | NA | 0.073 | NA | 1,258.6 | NA | 0.027 |

*Counties with a high index link (sufficient counties) are those that have substantially high infective connectivity indices (at last 3.5 times greater than 2 SDs), link with at least 2 other counties, and report infected cattle earlier than the other county sharing the infective link.
†Counties without a high index link (necessary counties) are those that report infected cattle during the first 3 days of the epidemic (minimal time for the replication cycle of FMD virus) and hence are hypothesized to be primary cases and also have link indices within the mean + 2 SDs.
‡County No. 1707 is a county with a high index link that reported infected cattle during the first 3 days of the epidemic (primary cases).
§Expressed in percentages, counties with a high index link reported >2 times as many cases (332/160[207.5%]) as counties without a high index link. Expressed as area, total surface for counties with a high index link represented almost half that for counties without a high index link (3,737.8 km²/7,000.0 km² [58.4%]). Expressed as total number of cases prevented per km², a control campaign implemented in counties with a high index link could have prevented 3.5 times more cases per square kilometer than a similar campaign implemented in counties without a high index link (0.478/0.138 = 3.51).
∥Expressed as median number of cases prevented per county, a control campaign implemented in counties with a high index link could have prevented 0.073 cases/km², which was significantly (P = 0.02 Mann-Whitney test) higher than the number of cases prevented per county (0.027 cases/km²) had the same control campaign been implemented in counties without a high index link.
NA = Not applicable.

All counties reporting primary cases did not appear to facilitate spread of the disease during the epidemic. Four of 5 counties that had the highest link indices and connected with at least 2 other counties had 2.5 times as many cases by week 11 as 4 of 5 counties that contained cattle infected during days 1 to 3 of the epidemic. The second group of counties (counties with a high index link) reported their first infected animal on days 4 to 6 of the epidemic (time frame compatible with a secondary infection); which combined with another high index link county that reported an infected animal at day 1 to 3, this provided a county median of 0.073 cases/km² by week 11, whereas the remaining counties reporting cases at days 1 to 3 (none of which were high index link counties) had significantly (P=0.02; Mann-Whitney test) fewer infected cattle (county median, 0.027 cases/km²) by week 11 (Table 3). Counties with a high index link (n=5) also had a significantly (P=0.01) higher median road density (0.26 km/km²), compared with the 271 other counties with infected cattle (0.126 km/km²).

Because observational epidemiologic analyses do not allow experimental designs, theories can only use historical data to attempt validation. However, such data may possess unknown sources of bias or lack critical variables. For example, the number of farms considered in the study reported here was based on the 2000 Agricultural Census, a data set not necessarily applicable for the study of this epidemic. Accordingly, the model described should not be perceived as an analysis of the FMD epidemic that took place in Uruguay in 2001 but, instead, as an evaluation of a spatial method that uses a hypothetical (although realistic) scenario for the epidemic. Despite that caveat, the analysis of assumptions on which spatial autocorrelation was based revealed adequate sample size (>20 county pairs/observation) and no departure from normality.29 Two measures of spatial-temporal autocorrelation (with and without consideration of denominator data) yielded similar results. Similar week-specific correlograms suggested that delayed reporting did not bias these findings. The use of Euclidean and non-Euclidean distances was justified by the fact that there was a maximized spatial autocorrelation index when variable a=0.46 and variable b=0.06.6

Significant positive (<120 km between counties with infected animals) and negative (>120 but <400 km between counties with infected animals) spatial autocorrelations were observed every week for at least the first 5 weeks (FIGS. 6A-6B). Such findings suggested that, once structured, the epidemic network was rather robust and static. Three major spatial autocorrelation patterns have been described42: a monotonic decreasing pattern (a positive-only significant autocorrelation without a significant negative autocorrelation; also known as a patchy pattern); a bimodal pattern characterized by significant positive spatial autocorrelation for short-distance lags, followed by significant negative spatial autocorrelation for long-distance lags, as was evident in the study reported here; and lack of spatial patterns (when the Moran I coefficient is not significant). Although monotonic and decreasing Moran indices (e.g., lacking a significant negative autocorrelation) are usually found in other fields, negative structures are not rare in epidemiologic investigations.29 Possible causes of significant negative autocorrelations include poor local connectivity for 1 member of county pairs (e.g., lower road density, factor associated with lower farm density, or fewer adjacent farms).24,25 A correlogram pattern with significant positive and negative autocorrelations for short- and long-distance lags, respectively, can be interpreted as a linear gradient at macroscales such that when 1 member of the pair is situated farther than a certain critical distance from the other member of the pair, case prevalence typically has opposite values.42 Nonsignificant links at even greater distances for lags (>400 km) resembled small-world-like connections.5 As indicated by the lack of significance, such connections do not necessarily result in additional disease spread during an epidemic because local conditions (i.e., poorer local connectivity) may prevent viral dispersal

Spatial analysis facilitated data-driven generation of hypotheses. Counties with infected cattle could be categorized as possessing greater potential for disease dispersal during the epidemic on the basis of 3 criteria (having a high index link [i.e., to be an outlier or county with a high index link], connecting with ≧2 other counties, and reporting infections before the other member of the pair). Counties reporting infections on days 1 to 3 of the outbreak (primary cases) were regarded as necessary sites, whereas those displaying higher index links (and connecting with at least 2 additional counties) were hypothesized to possess greater risk for other counties (sufficient cause of disease spread during the epidemic). Counties paired with those that had sufficient cause of disease spread were suspected to be target sites. This working hypothesis distinguished counties infected first (necessary causes, although not necessarily the cause of disease spread) from those that had a high index link (i.e., those hypothesized to seed new cases into target sites), regardless of when and where they got the infection. This conceptualization is similar to that of a model in which it was proposed that spatial features result in differing diffusion models during an epidemic.40 Although daily data on time of detection of infected animals facilitate the richest generation of hypotheses, even when such data are not available or are available but not used because of possible errors (e.g., delayed reporting and underreporting), information on link indices alone identifies county pairs that have indices much higher than the mean (outliers suspected to influence disease dispersal).

Although other factors associated with disease spread during an epidemic (i.e., markets) cannot be ruled out, spatial analysis may generate evidence of case clustering, whether there are short- or long-distance connections (or both), and whether there are changes in location of cases over time in relation to interventions. Identification of infected sites with greater epidemic risk (counties with a high index link) did not support the hypothesis that all infected cattle had equal influence on disease spread nor the theory of homogeneous mixing, which assumes that all susceptible and infected cattle are located at similar distances from each other and possess similar risk for becoming infected or for infecting others.40 This theory results in undifferentiated control policies, such as implementation of buffer rings (i.e., regional circles of fixed diameter within which the same control policy is conducted). 43 The fact that the first county with infected cattle and 3 other counties in which there were primary infections apparently failed to promote disease spread also argued against the homogeneous mixing theory.

Spatially explicit assessment of infective connectivity may be applied to evaluate control policy. For example, when only 2 time periods were considered, spatial autocorrelation analysis revealed a reduction of approximately 40 km in the mean distance between counties for the cluster (from 120 km at weeks 1 and 2 to 80 km at weeks 3 through 11), which supports the hypothesis that vaccination reduced disease spread during the epidemic. However, evaluation of week-specific correlograms did not reveal evidence of regional differences up to week 6 of the epidemic, which suggests that the 40-km reduction may reflect the end of the epidemic (when many counties did not report cases). These results may support the hypothesis that the conclusion of the epidemic was attributable to several factors, including lack of susceptible herds and a ban on animal movement that was imposed in week 1.

The approach described here was also informative, facilitating the explanation of apparent contradictions.

Although a second cluster was suggested by correlograms for sites located at >400 km between counties with infected cattle before and after vaccination was conducted, which is in agreement with the expected limited disease dispersal for infected animals located at the edge of the territory being infected, 40 the cluster at >400 km was not significant (FIGS. 5A-5C, 6A-6B, and 9A-9C). However, at weeks 1 and 2, link analysis identified 2 counties that had a high index and long-distance connections. The contradiction between (global) correlogram analysis and link analysis may be explained once local factors are considered (i.e., edge effects and a lower density of local roads in target counties connected by long-distance links may prevent further disease dispersal because there is poor local connectivity).

Cost-benefit analysis may also be generated by the approach used in the study reported here. Had a policy focusing on all counties reporting primary cases been adopted (on the basis of the theory that all cases equally contribute to disease spread during an epidemic), it may have been inefficient and insufficient. In contrast, a policy focused on high-index link counties could have been 2.5 to 3 times more beneficial than undifferentiated control policies (Table 3). Observations of significant case clustering and significant negative autocorrelation (for counties located >120 to <400 km between counties with infected cattle), noticed as early as week 2 (when vaccination had not been implemented), could have led to differentiated control measures (i.e., regionalization). 44

Infective link analysis can be interpreted by considering epidemics as processes that connect at least 2 points through a line. The local Moran test has been used 12, 45, 46 to focus on the contribution of each point to the overall (global) spatial autocorrelation. In contrast, the method described here focused on the line connecting the 2 points. Although local Moran tests assess inputs and outputs, infective connectivity emphasizes the intermediate process that takes place at some time point before the outcome is noticed. Such emphasis informs on earlier phenomena, which can be used to generate hypotheses on factors facilitating (or preventing) disease dispersal during an epidemic and possibly to identify case clustering in adjacent sites and in sites located far apart from each other. When based on data of a smaller scale (i.e., farm-level data), spatial autocorrelation and link analysis may facilitate real-time control of rapidly disseminated diseases.

Based on the above example the inventors have expanded the invention and the following information will aid in further calculations.

### Monitoring Attribute Patterns

A procedure aimed at monitoring attribute patterns over space and/or time such that it generates non-overlapping diagnostic hypotheses. Monitoring is based on, at least:

1) the geocoded data from each spatial point (e.g., farm),
2) the inter-point (e.g., interfarm) (Euclidean) distances,
3) the date each observation was recorded,
4) the identifier corresponding to each individual (e.g., a cow), and
5) the identifier corresponding to each attribute (e.g., a bacterial strain) corresponding to each individual and date.

Based on data described above, the following indicators are then created:

1) the intrapoint or interpoint (e.g., interfarm or intrafarm) attribute ratio or INTER-P AR/INTRA-P AR (the number of individual attributes [e.g., one bacterial strain] expressed as percentage of all attributes at a given spatial point/date,
2) the attribute spatial spread or A-DISTNC (the distance assumed to be traveled by a given attribute, as calculated from the interfarm distance matrix, expressed in km or miles),
3) the attribute spread velocity or A-SPEED (distance traveled by an individual attribute/time, e.g., km/year), and
4) the product of the interfarm attribute ratio times the attribute spread velocity (INTRA-P AR times A-SPEED), or attribute geo-temporal spread index (A-GTSI), which may be expressed with and without adjustment for the average number of spatial points where a given attribute has been recorded per individual attribute/per unit of time.

These indicators are then used to:
1) hypothesize disease as due to “non-local” factors (i.e., due to specific A's), when greater than average A-GTSI are observed,
2) hypothesize disease as due to “local, environmental” factors (e.g., individual farms), when higher than average INTRA-P AR and/or lower than average A-SPEED were generated) are observed, and
3) hypothesize disease as due to “local, individual” factors (e.g., cow-related), when low INTRA-P AR and/or low A-SPEED are observed.

### Cluster Detection and Connectivity Analysis

### Cluster Detection

A procedure aimed at detecting aggregations of individuals displaying greater/lower than average values of some attribute than those of the population at large (clusters) which may or may not possess high/low influence in the dissemination of that attribute within the population at large (with a high/low degree of connectivity).

Cluster detection is meant to refer to:

1) the spatial location of the cluster (composed of, at least, 2 “points” [e.g., cities]), and

2) the magnitude of clustering.

Cluster detection is based on, at least, these 6 factors:
1) the spatial location of each point (e.g., a city's coordinates),
2) the inter-point distance (whether Euclidean or non-Euclidean),
3) the magnitude of the attribute of interest at each point (e.g., the prevalence or percent of children infected with the flu virus at a given school),
4) the number of links per spatial point (with the attribute),
5) the link index (the “weight” or “width” of each link), and
6) (if available) the time the attribute has been reported.

### Connectivity Analysis

A procedure aimed at estimating the connectivity of a point pertaining to a network. Connectivity analysis is based on 2 (or 3) factors:

1) the number of links per “node” (“point”),
2) the link index (the “weight” or “width” of each link), and
3 (if available) the time the attribute has been reported. Alone or combined, these factors can be used to identify and/or rank individual clusters. The number of links and the link index are defined. Alone or combined, these factors can be used to estimate the connectivity (expressed as a rank or degree) in relation to the network that point is associated to.

### Cost-Benefit Based Decision-Making

A procedure aimed at informing decisions based on cost-benefit like analyses that uses cluster detection and/or cluster connectivity data.

The population at large, upon which more beneficial/less costly decisions are to be made, is identified by a variety of procedures, including:
1) determination of the average cluster size (diameter, expressed in kilometers or miles), based on inter-point Euclidean distances (as reported in the attached example, by using Ripley's K function),
2) determination of the actual cluster size,
3) determination of the number of individuals located at each point, by using georeferenced data,
4) comparison of benefits and/or costs, expressed as ratios between the susceptible population (potential benefits or protected individuals) and the intervened population (that on which there is knowledge on some attribute, as measured above), in any of these forms:
   a) higher number of benefited/protected cases on per square kilometer basis per each intervened square kilometer,
   b) larger ratio of protected/benefited units (individuals, spatial points) per intervened unit (individuals, spatial points), as here described,
   c) smaller territory/fewer spatial points to be intervened per benefit unit, as here described,
   d) optimal number of benefits (e.g., protected individuals) per cost unit (e.g., intervented individuals, intervened spatial points) as determined by ROC analysis and based on georeferenced data (as here described).

Since other modifications and changes varied to fit particular operating requirements and environments will be apparent to those skilled in the art, this invention is not considered limited to the example chosen for purposes of this disclosure, and covers all changes and modifications which does not constitute departures from the true spirit and scope of this invention.

Having thus described the invention, what is desired to be protected by Letters Patent is presented in the subsequently appended claims.

### REFERENCES AND FOOTNOTES

a. Arc View GIS 3.3, ESRI, Redlands, Calif.
b. Arc View 8.0, ESRI, Redlands, Calif.
c. Geographic Service, Ministry of Defense, Montevideo, Uruguay.
d. Matlab, Mathworks, Inc, Natick, Mass.
e. Minitab 14, Minitab, State College, Pa.
1. Rainham D G C. Ecological complexity and West Nile Virus-perspectives on improving public health response. Can JPublic Health 2005; 96:37-40.
2. Langlois J P, Fahrig L, Merriam G, et al. Landscape structure influences continental distribution of hantavirus in deer mice. Landscape Ecol 2001; 16:255-266.
3. Wilesmith J W, Stevenson M A, King C B, et al. Spatio-temporal epidemiology of foot-and-mouth disease in two counties of Great Britain in 2001. Prev Vet Med 2003; 61:157-170.
4. Milgram S. Small-world problem. Psychol Today 1967; 1:61-67.
5. Watts D J, Strogatz S H. Collective dynamics of ‘small-world’ networks. Nature 1998; 393:440-442.
6. Cliff A D, Ord J K. Measures of autocorrelation in the plane; and Distribution theory for the join-count, I, and c statistics. In: Cliff A D, Ord J K, eds. Spatial processes: models and applications. London: Pion Ltd, 1981; 1-65.
7. Bollobás B. Models of random graphs. In: Bollobás B, Fulton W, Katok A, et al, eds. Random graphs. Cambridge Studies in Advanced Mathematics 73. Cambridge, UK: Cambridge University Press, 2001; 34-50.
8. Morris R S, Wilesmith J W, Stern M W, et al. Predictive spatial modelling of alternative control strategies for the foot-and-mouth disease epidemic in Great Britain, 2001. Vet Rec 2001; 149:137-144.
9. Jules E S, Kauffman M J, Ritts W D, et al. Spread of an invasive pathogen over a variable landscape: a normative root rot on Port Orford cedar. Ecology 2002; 83:3167-3181.
10. Hawbaker T J, Radeloff V C. Roads and landscape pattern in northern Wisconsin based on a comparison of four road data sources. Conserv Biol 2004; 18:1233-1244.
11. Lam N S N, Fan M, Liu K B. Spatial-temporal spread of the AIDS epidemic, 1982-1990: a correlogram analysis of four regions of the United States. Geogr Anal 1996; 28:93-107.
12. Cocu N, Harrington R, Hulle M, et al. Spatial autocorrelation as a tool for identifying the geographical patterns of aphid annual abundance. Agric Forest Entornol 2005; 7:31-43.
13. Moran P A P. Notes on continuous stochastic phenomena. Biometrika 1950; 37:17-23.
14. Knox E G. The detection of space-time interactions. J Appl Stat 1964; 13:25-29.
15. Mantel N. The detection of disease clustering and a generalized regression approach. Cancer Res 1967; 27:209-220.
16. Jacquez G M. A k-nearest neighbour test for space-time interaction. Stat Med 1996; 15:1935-1949.
17. Baker R D. Testing for space-time clusters of unknown size. J Appl Stat 1996; 23:543-554.
18. Norström M, Pfeiffer D U, Jarp J. A space-time cluster investigation of an outbreak of acute respiratory disease in Norwegian cattle herds. Prev Vet Med 2000; 47:107-119.
19. Turnbull B, Iwano E J, Burnett W S, et al. Monitoring for clusters of disease: application in leukemia incidence in upstate New York. Am J Epidemiol 1990; 132 (suppl 1): S136-S143.
20. Kulldorff M, Athas W F, Feuer E J, et al. Evaluating cluster alarms: a space-time scan statistic and brain cancer in Los Alamos, N. Mex. Am J Public Health 1998; 88:1377-1380.
21. Patil G P, Taillie C. Upper level set scan statistic for detecting arbitrarily shaped hotspots. Environ Ecol Stat 2004; 11:183-197.
22. Tango T, Takahashi K. A flexibly shaped spatial scan statistic for detecting clusters. Int J Health Geogr 2005; 4:11. Available at: www.ijhealthgeographics.com/content/4/1/11. Accessed MONTH DATE, YEAR.
23. Rivas A L, Tennenbaum S E, Aparicio J P, et al. Critical response time (time available to implement effective measures for epidemic control): model building and evaluation. Can J Vet Res 2003; 67:307-315.
24. Rivas A L, Smith S D, Sullivan P J, et al. Identification of geographic factors associated with early spread of foot-and-mouth disease. Am J Vet Res 2003; 64:1519-1527.
25. Rivas A L, Schwager S J, Smith S, et al. Early and cost-effective identification of high risk/priority control areas in foot-and-mouth disease epidemics. J Vet Med B Infect Dis Vet Public Health 2004; 51:263-271.
26. Alexandersen S, Quan M, Murphy C, et al. Studies of quantitative parameters of virus excretion and transmission in pigs and cattle experimentally infected with foot-and-mouth disease virus. J Comp Pathol 2003; 129:268-282.
27. Keeling M J, Woolhouse M E J, Shaw D J, et al. Dynamics of the 2001 UK foot and mouth epidemic: stochastic dispersal in a heterogeneous landscape. Science 2001; 294:813-817.
28. Durr P A, Froggatt A E A. How best to geo-reference farms? A case study from Cornwall, England. Prev Vet Med 2002; 56:51-62.
29. Glavanakov S, White D J, Caraco T, et al. Lyme disease in New York state: spatial pattern at a regional scale. Am J Trop Med Hyg 2001; 65: 538-545.
30. Kao R R. The role of mathematical modelling in the control of the 2001 FMD epidemic in the UK. Trends Microbiol 2002; 10:279-286.
31. European Commission-Health and Consumer Protection Directorate-General. Final report of a mission carried out in Uruguay from 25 to 29 Jun. 2001 in order to evaluate the situation with regard to outbreaks of foot and mouth disease. DG(SANC0)/3342/2001. Brussels: European Commission, 2001. Available at: europa.eu.int/comm/food/fs/inspections/vi/reports/uruguay/vi_rep_urug_{—}3342-2001_en.pdf. Accessed Aug. 26, 2005.
32. European Commission-Health and Consumer Protection Directorate-General. Final report of a mission carried out in Uruguay from 1 to 4 Oct. 2001 in order to evaluate the controls in place over foot and mouth disease. DG(SANC0)/3456/2001. Brussels: European Commission, 2001. Available at: europa.eu.int/comm/food/fs/inspections/vi/reports/uruguay/vi_rep_urug_{—}3456-2001_en.pdf. Accessed Aug. 26, 2005.
33. Doel T R. FMD vaccines. Virus Res 2003; 91:81-99.
34. Ministry of Agriculture, Livestock and Fisheries (MGAP). MGAP home page. Montevideo, Uruguay Available at: www.mgap.gub.uy. Accessed Jul. 15, 2001.
35. Ministry of Agriculture, Livestock and Fisheries (MGAP). Directory of Agricultural Statistics. 2000-2003 annals [database online]. Montevideo, Uruguay. Available at: www.mgap.gub.uy/diea/Anuario2003/Default.htm. Accessed Sep. 10, 2005.
36. Ministry of Agriculture, Livestock and Fisheries (MGAP). Directory of Agricultural Statistics. 2003 annals [database online]. Montevideo, Uruguay. Available at: www.mgap.gub.uy/diea/Anuario2003/. Accessed Sep. 9, 2005.
37. Ministry of Agriculture, Livestock and Fisheries (MGAP). Directory of Agricultural Statistics. 2000 agricultural census [database online]. Montevideo, Uruguay. Available at: www.mgap.gub.uy/Diea/CENS02000/censo_general_agropecuario_{—}2000.htm. Accessed Aug. 26, 2005.
38. Murray G D, Cliff A D. A stochastic model for measles epidemics in a multi-region setting. Trans Inst Br Geogr 1975; 2:158-174.
39. Hanski I. Metapopulation dynamics. Nature 1998; 396:41-49.
40. Filipe J A N, Maule M M. Effects of dispersal mechanisms on spatio-temporal development of epidemics. J Theor Biol 2004; 226:125-141.
41. Xia Y, Bjørnstad O N, Grenfell B T. Measles metapopulation dynamics: a gravity model for epidemiological coupling and dynamics. Am Nat 2004; 164:267-281.
42. Felizola Diniz-Filho J A, Bini L M, Hawkins B A. Spatial autocorrelation and red herrings in geographical ecology. Global Ecol Biogeogr 2003; 12:53-64.
43. Müller J, Schönfisch B, Kirkilionis M. Ring vaccination. J Math Biol 2000; 41:143-171.
44. Tinline R R, MacInnes C D. Ecogeographic patterns of rabies in southern Ontario based on time series analysis. J Wildl Dis 2004; 40:212-221.
45. Getis A, Ord J K. The analysis of spatial association by use of distance statistics. Geogr Anal 1992; 24:189-206.
46. Anselin L. Local indicators of spatial association-LISA. Geogr Anal 1995; 27:93-115. 12 AJVR, Vol 67, No. 1, January 2006

What is claimed is:

1. A method of identifying clusters from a set of points selected from the group consisting of individual points and spatial points comprising:
a) selecting a geographic area;
b) acquiring data on the spatial coordinates that characterize the selected geographic area;
c) selecting attributes to be measured for each point of the set;
d) processing the attributes of each point;
e) determining the linkage between the points based on the attributes;
f) identifying from the group comprising the spatial coordinates and time of any point having an attribute deviating significantly from the average point in the set as a cluster.

2. A method of determining connectivity between a set of points selected from the group consisting of individual points and spatial points comprising:
a) selecting a geographic area;
b) acquiring data on the spatial coordinates that characterize the selected geographic area;
c) selecting attributes to be measured for each point of the set;
d) processing the attributes of each point;
e) determining the linkage between the points based on the attributes;
f) identifying the magnitude of the attributes of any point having an attribute deviating significantly from the average point in the set as a cluster.

3. A method for prediction of the spread of an epidemic outbreak of a disease comprising:
a) selecting a geographic area;
b) acquiring data on the spatial coordinates that characterize the selected geographic area;
c) selecting disease attributes to be measured for each point of the set;
d) processing the attributes of each point;
e) determining the linkage between the points based on the attributes;
f) determining the rate of change of the attributes over time.

4. A method according to claim 3 wherein a geographical information system is used.

5. A method according to claim 3 wherein the epidemic outbreak is in an animal population.

6. A method according to claim 3 wherein the epidemic outbreak is in a human population.
